(19) United States
(12) Patent Application Publication
(10) Pub. No.: US 2013/0189955 A1
(43) Pub. Date: Jul. 25, 2013

(54) METHOD FOR CONTEXT ESTABLISHMENT IN TELECOMMUNICATION NETWORKS

(71) Applicants: Guenther Horn, Munich (DE); Robert Zaus, Munich (DE)

(72) Inventors: Guenther Horn, Munich (DE); Robert Zaus, Munich (DE)

(73) Assignee: NOKIA SIEMENS NETWORKS OY, Espoo (FI)

(21) Appl. No.: 13/824,561

(22) PCT Filed: Sep. 17, 2010
(86) PCT No.: PCT/EP10/63697

§ 371 Date: Mar. 18, 2013

(51) Int. Cl. H04W 12/06

(52) U.S. Cl. CPC H04W 12/06
USPC 455/411; 455/435.1

(57) ABSTRACT

A method is provided comprising receiving a group registration request from a master device, sending a request relating to the master device to a subscriber database, and receiving subscriber specific information relating to a member device from said subscriber database. The member device is controlled by the master device and the subscriber specific information relating to the member device is associated with the master device or with subscriber specific information relating to said master device in the subscriber database.

### FIELD OF THE INVENTION

The exemplary and non-limiting embodiments of this invention relate generally to communications networks and particularly to mobile telecommunication networks. More specifically, certain embodiments of the invention are directed to methods, apparatuses and systems for machine type communications.

### BACKGROUND ART

Machine to machine (M2M) communication is about enabling the flow of data between machines and machines and ultimately machines and people. Regardless of the type of machine or data, information usually flows in the same general way from a machine over a network, and then through a gateway to a system where it can be reviewed and acted on. The wide coverage of mobile telecommunication networks can meet the requirements of M2M services and devices for ubiquitous connectivity. Despite the current low penetration rate, M2M services enabled by mobile networks have a huge potential for growth.

Network requirements for M2M communications are being studied by standardization bodies. For example, 3^{rd} generation partnership project (3GPP) has a M2M study item referred to as Machine Type Communications (MTC). MTC involves one or more entitles that do not necessarily need human interaction. MTC is low mobility, time controlled, time tolerant, packet switched only and mobile originated only. MTC services occupy low bandwidth as they are broadly intended for measurement and data transmission. Compared with the massive traffic loads generated by mobile broadband services, MTC service traffic flows will remain steady over time.

3GPP is currently working on network improvements for machine type communications (NIMTC). Machine type communications are expected to eventually lead to many more users attaching to the network than at present, and show different characteristics from human user orientated communication. Therefore, enhancements are being studied to increase the efficiency of the present packet switching networks with respect to MTC.

An MTC device is a mobile device capable of machine type communications. An MTC device comprises a mobile equipment (ME) and a universal subscriber identity module (USIM). A MTC group is a group of MTC devices that share one or more group based MTC features and that belong to the same MTC subscriber. One MTC subscriber can have several active MTC devices, each having own unique international mobile subscriber identity (IMSI).

One of the enhancements to NIMTC being proposed has become known under the name of “group authentication” meaning that a whole group of MTC can be authenticated to the network in one authentication procedure, instead of running separate authentication procedures for each of the devices. So far, only requirements have been formulated, and scenarios, in which group authentication may be useful, have been described, but no solution has been provided.

### SUMMARY

It is therefore an object of this invention to address some of the above mentioned problems by providing methods, apparatuses, a system, and a computer program product as defined in the independent claims. Some of the further embodiments of the invention are disclosed in the dependent claims.

According to first aspect of the invention, there is provided a method for group registration of mobile terminals in a telecommunication network comprising receiving a group registration request from a master device, sending a request relating to said master device to a subscriber database, and receiving subscriber specific information relating to at least one member device from said subscriber database, wherein said at least one member device is controlled by said master device and said subscriber specific information relating to said at least one member device is associated with said master device or with subscriber specific information relating to said master device in said subscriber database. The said at least one member device may comprise one or a number of member devices.

According to a further embodiment, the method further comprises deriving a mobility management context for said at least one member device based on said received subscriber specific information relating to said at least one member device. In some embodiments, said mobility management context comprises a temporary mobile subscriber identity and said temporary mobile subscriber identity may be derived using said received subscriber specific information relating to said at least one member device. In some embodiments, said mobility management context comprises a tracking area identifier, a location area identifier or a routing area identifier, or all of them.

According to a further embodiment, the method further comprises sending at least one of said temporary mobile subscriber identity, said tracking area identifier, said location area identifier and said routing area identifier to said master device or to said at least one member device.

According to a further embodiment, the method comprises receiving at least one security parameter from said subscriber database. In some embodiments, said security parameter relates to said master device or to said at least one member device. In some embodiments, said received security parameter comprises an authentication parameter (e.g. authentication vector or authentication challenge), a security key (e.g. IK, CK, Kc, K_{ASME} or Ki) or a key identifier (e.g. KSI or CKSN). In some embodiments, said security parameter is used together with subscriber specific information related to said at least one member device to derive security keys for said at least one member device. In some embodiments, said received security parameter comprises an authentication vector associated with said at least one member device.

According to a further embodiment, the method comprises sending at least one security parameter to said master device or to said at least one member device, wherein said at least one security parameter relates to said at least one member device. In some embodiments, the method further comprises sending said at least one security parameter together with said at least one subscriber specific information relating to said at least one member device. In some embodiments, said sent security parameter comprises an authentication parameter (e.g. authentication vector or authentication challenge), a security key (e.g. IK, CK, Kc, K_{ASME} or Ki) or a key identifier (e.g. KSI or CKSN).

According to a further embodiment, said at least one member device is a member of a machine type communications (or M2M) device group and said master device is configured to control said at least one member device of said machine type communications device group. In some embodiments, said master device is configured to perform authentication or registration or to initiate authentication or registration on behalf of said at least one member device of said machine type communications device group.

According to a further embodiment, said subscriber specific information relating to at least one member device is received during authentication or during registration.

According to a further embodiment, said subscriber specific information relating to said at least one member device is international mobile subscriber identity or a parameter associated with international mobile subscriber identity and, in some embodiments, said subscriber specific information relating to said at least one member device takes a form of a list of international mobile subscriber identities.

According to a further embodiment, said receiving comprises receiving at a mobility management entity or at a serving general packet radio service support node. In some embodiments, said subscriber database comprises a home subscriber server or a home location register.

According to a second aspect of the invention, there is provided a network node, for example a mobility management entity (MME) or at a serving general packet radio service support node (SGSN) comprising a first input (or some other receiving means) configured to receive a group registration request from a master device, an output (or some other sending means) configured to send a request relating to said master device to a subscriber database, and a second input configured to receive subscriber specific information relating to at least one member device from said subscriber database, wherein said at least one member device is controlled by said master device and said subscriber specific information relating to said at least one member device is associated with said master device or with subscriber specific information relating to said master device in said subscriber database. In some embodiments said first input and said second input are comprised in one input. In some embodiments, said first or second input comprises a receiver. In some embodiments, said output comprises a transmitter.

According to a further embodiment, the mobile device further comprises a processor (or some other processing means) configured to derive at least one of a mobility management context and a security context for said at least one member device based on said received subscriber specific information relating to said at least one member device. In some embodiments, said mobility management context comprises a temporary mobile subscriber identity and said temporary mobile subscriber identity is derived using said received subscriber specific information relating to said at least one member device. In some embodiments, said mobility management context comprises at least one of a tracking area identifier, a location area identifier and a routing area identifier.

According to a further embodiment, said second input is further configured to receive at least one security parameter from said subscriber database. In some embodiments, said at least one security parameter relates to said master device. In some embodiments, said processor is further configured to derive security keys for said at least one member device based on said at least one security parameter relating to said master device and said subscriber specific information related to said at least one member device. According to some embodiments, said at least one security parameter relates to said at least one member device. In some embodiments, said received security parameter comprises an authentication parameter (e.g. authentication vector or authentication challenge), a security key (e.g. IK, CK, Kc, K_{ASME} or Ki) or a key identifier (e.g. KSI or CKSN). In some embodiments, said received security parameter comprises an authentication vector associated with said at least one member device.

According to a further embodiment, said output is configured to send at least one security parameter to said master device or to said at least one member device. In some embodiments, said at least one security parameter relates to said at least one member device. In some embodiments, said output is further configured to send said at least one security parameter together with said at least one subscriber specific information relating to said at least one member device. In some embodiments, said at least one security parameter comprises an authentication parameter (e.g. authentication vector or authentication challenge), a security key (e.g. IK, CK, Kc, _{KASME} or Ki) or a key identifier (e.g. KSI or CKSN).

According to a further embodiment, said at least one member device is a member of a machine type communications (or M2M) device group and said master device is configured to control said at least one member device of said machine type communications device group. In some embodiments, said master device is configured to perform authentication on behalf of said at least one member device of said machine type communications device group. In some embodiments, said master device is configured to perform registration or authentication or to initiate authentication or registration on behalf of said at least one member device of said machine type communications device group.

According to a further embodiment, said subscriber specific information relating to at least one member device is received during authentication or during registration.

According to a further embodiment, said subscriber specific information relating to said at least one member device is international mobile subscriber identity or a parameter associated with international mobile subscriber identity and, in some embodiments, said subscriber specific information relating to said at least one member device takes a form of a list of international mobile subscriber identities.

According to a further embodiment, said subscriber database comprises a home subscriber server or a home location register.

According to a third aspect of the invention, there is provided a subscriber database, for example a home subscriber server (HSS) or a home location register (HLR), comprising a memory (or some other storing means) configured to store subscriber specific information relating to a master device and subscriber specific information relating to at least one member device, a input (or some other receiving means) configured to receive a request relating to said master device from a network node, and a output (or some other sending means) configured to send subscriber specific information relating to at least one member device to said network node, wherein said at least one member device is controlled by said master device and said subscriber specific information relating to said at least one member device is associated with said master device or with subscriber specific information relating to said master device in said memory.In some embodiments, said input comprises a receiver. In some embodiments, said output comprises a transmitter.

According to a further embodiment, said output is further configured to send at least one security parameter to said network node. In some embodiments, said at least one security parameter relates to said master device. In some embodiments, said at least one security parameter relates to said at least one member device. In some embodiments, said at least one security parameter comprises an authentication parameter (e.g. authentication vector or authentication challenge), a security key (e.g. IK, CK, Kc, K_{ASME} or Ki) or a key identifier (e.g. KSI or CKSN). In some embodiments, said received security parameter comprises an authentication vector associated with said at least one member device.

According to a further embodiment, said at least one member device is a member of a machine type communications (or M2M) device group and said master device is configured to control said at least one member device of said machine type communications device group. In some embodiments, said master device is configured to perform authentication or registration or to initiate authentication or registration on behalf of said at least one member device of said machine type communications device group.

According to a further embodiment, said output is further configured to send said subscriber specific information relating to at least one member device during authentication. In some embodiments, said output is further configured to send said subscriber specific information relating to at least one member device during registration.

According to a further embodiment, said subscriber specific information relating to said at least one member device is international mobile subscriber identity or a parameter associated with international mobile subscriber identity and, in some embodiments, said subscriber specific information relating to said at least one member device takes a form of a list of international mobile subscriber identities.

According to a further embodiment, said network node comprises a mobility management entity or at a serving general packet radio service support node.

According to a fourth aspect of the invention, there is provided a mobile device, for example a master device of a mobile type communications device group, comprising an output (or some other sending means) configured to send a group registration request to a network node, a input (or some other receiving means) configured to receive subscriber specific information relating to at least one member device from said network node, wherein said at least one member device is controlled by said mobile device and said subscriber specific information relating to said at least one member device is associated with said mobile device or with subscriber specific information relating to said mobile device in said subscriber database. In some embodiments, said input comprises a receiver. In some embodiments, said output comprises a transmitter.

According to a further embodiment, said input is further configured to receive at least one of said temporary mobile subscriber identity, said tracking area identifier, said location area identifier and said routing area identifier from said network node. In some embodiments, said temporary mobile subscriber identity is derived using said subscriber specific information relating to said at least one member device.

According to a further embodiment, said input is further configured to receive at least one security parameter from said network node. In some embodiments, said at least one security parameter relates to said at least one member device. In some embodiments, said input is further configured to receive said at least one security parameter together with said at least one subscriber specific information relating to said at least one member device. In some embodiments, said at least one security parameter comprises an authentication parameter (e.g. authentication vector or authentication challenge), a security key (e.g. IK, CK, Kc, K_{ASME} or Ki) or a key identifier (e.g. KSI or CKSN). In some embodiments, said received security parameter comprises an authentication vector associated with said at least one member device.

According to a further embodiment, said output is further configured to send at least one of a temporary identity, a registration area, an authentication parameter (e.g.

authentication vector or authentication challenge), a security key (e.g. IK, CK, Kc, K_{ASME} or Ki), a key identifier (e.g. KSI or CKSN) and a session context to said at least one member device.

According to a further embodiment, said at least one member device is a member of a machine type communications (or M2M) device group and said mobile device is a master device configured to control said at least one member device of said machine type communications device group. In some embodiments, said mobile device is further configured to perform authentication or registration or to initiate authentication or registration on behalf of said at least one member device of said machine type communications device group.

According to a further embodiment, said subscriber specific information relating to said at least one member device is international mobile subscriber identity or a parameter associated with international mobile subscriber identity and, in some embodiments, said subscriber specific information relating to said at least one member device takes a form of a list of international mobile subscriber identities.

According to a further embodiment, said network node comprises a mobility management entity or at a serving general packet radio service support node.

According to fifth aspect of the invention, there is provided a system comprising said network node and said subscriber database.

According to a sixth aspect of the invention, there is provided a computer program product containing an executable code configured to perform a method according to any embodiment of the invention when executed in a computing device.

Although the various aspects, embodiments and features of the invention are recited independently, it should be appreciated that all combinations of them are possible and within the scope of the present invention as claimed.

Embodiment of the present invention may have one or more of following advantages:
reduced signaling over cellular air interface
reduced signaling in a serving network
reduced load on an authentication centre in a subscriber database
enhancements on group member registration procedure (e.g. speed)

### BRIEF DESCRIPTION OF DRAWINGS

In the following the invention will be described in greater detail by means of exemplary embodiments with reference to the attached drawings, in which:

FIG. 1 shows a system according to some embodiments of the invention.

FIG. 2 shows a flow chart of an embodiment of the invention (method).

FIG. 3 shows a simplified block diagram of another embodiment of the invention (a network node).

FIG. 4 shows a simplified block diagram of another embodiment of the invention (a subscriber server).

FIG. 5 shows a simplified block diagram of another embodiment of the invention (a mobile device).

### DETAILED DESCRIPTION OF SOME EMBODIMENTS

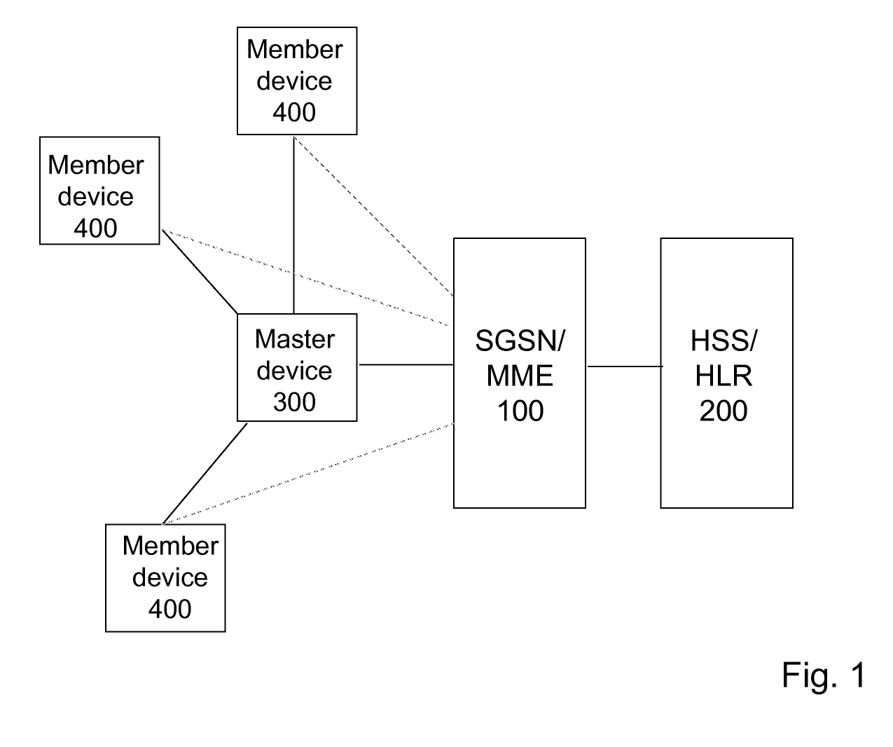

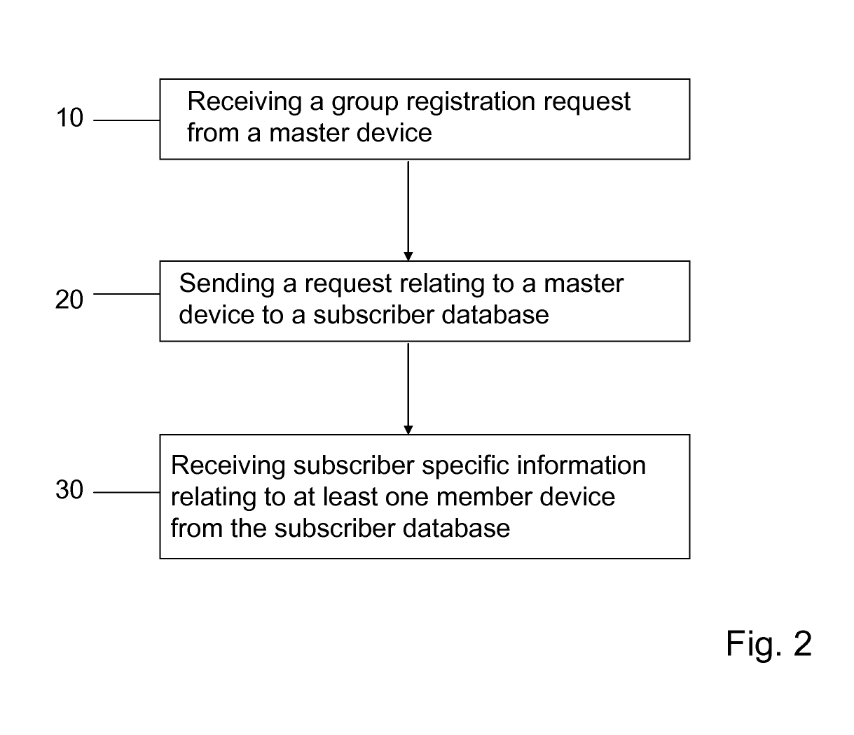

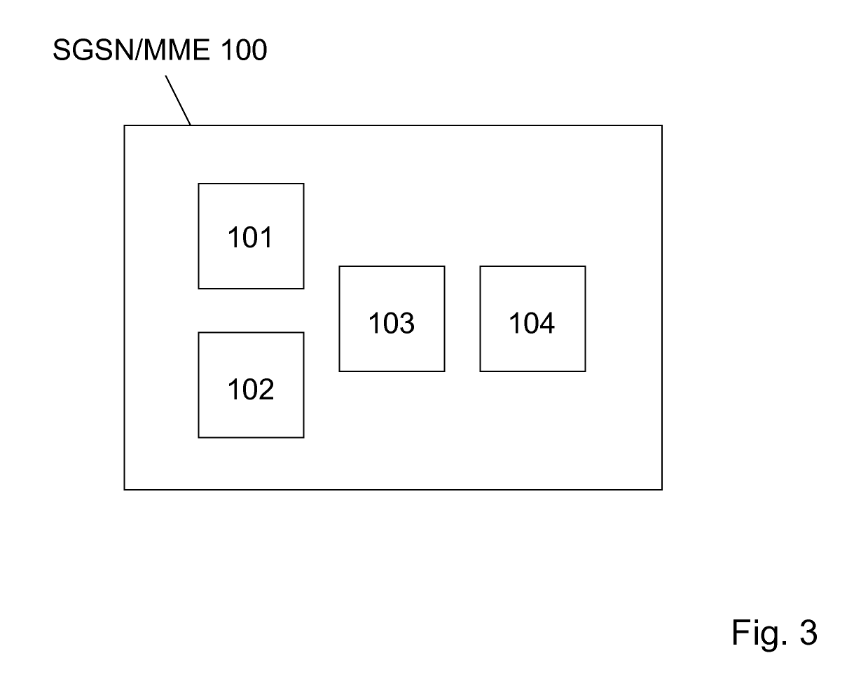

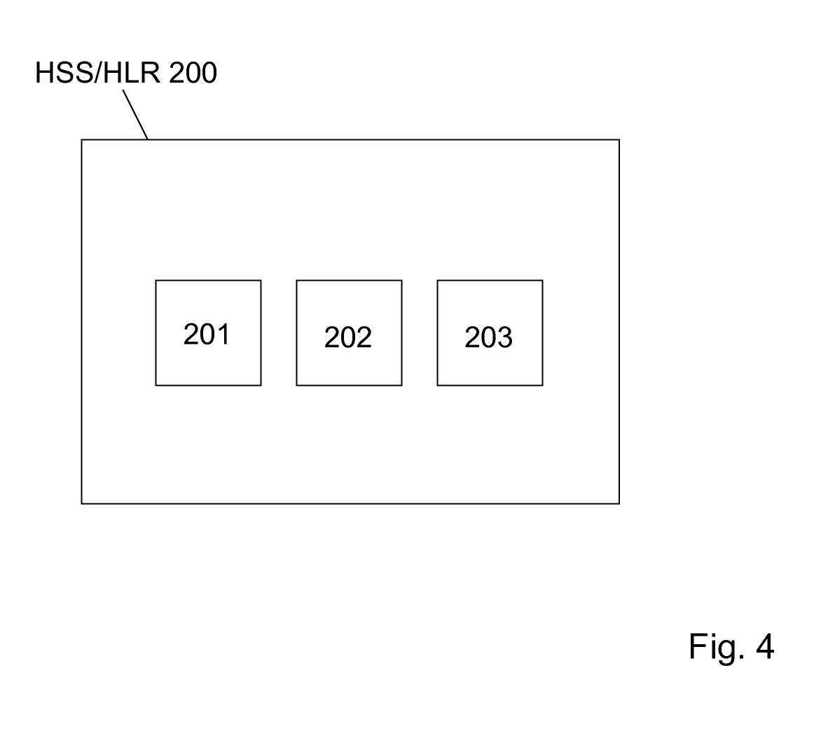

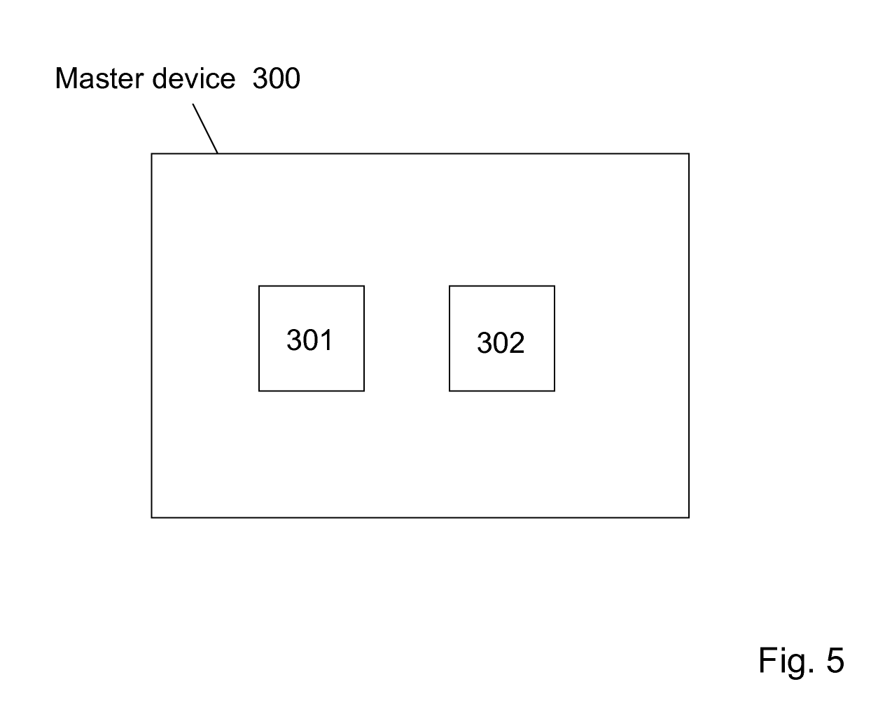

In the embodiments of the invention, as illustrated in FIGS. 1-5, there is a group of MTC devices with a master MTC device 300 and one or several member devices. In some embodiments, the master device 300 performs registration and authentication on behalf of the group member devices 400, i.e. it performs group registration with group authentication. In other embodiments, the master 300 only initiates authentication on behalf of the group member devices 400. Further, in all embodiments, the subscriber identity of the master device 300 is associated in the subscriber database 200 with the subscriber identities of the member devices 400 of the MTC group, and the subscriber identities are communicated from the subscriber server to a relevant network node 100 during registration and authentication. The subscriber identity may be e.g. international mobile subscriber identity (IMSI) and the subscriber database 200 may be e.g. a home subscriber server (HSS) or a home location register (HLR). The relevant network node 100 may be a serving GPRS (general packet radio service) support node (SGSN) of a 2G/3G network or a mobility management entity (MME) of a long term evolution (LTE) network.

In the first step, the master device 300 and the network node 100 perform a registration and authentication procedure as currently specified, with some possible additions to existing messages. These additions may in particular allow the following:
signaling from the master device 300 to the network node 100 that group registration and/or authentication is requested
confirmation of successful execution of group registration and/or authentication from the network node 100 to the master device 300
extended messages between the network node 100 and a subscriber database 200 (e.g. extended Authentication Data Request and/or Response messages)
to carry group related data (e.g. multiple IMSIs)
extended messages between the network node 100 and the master device 300 to carry additional information relating to the group members 400

As a result, the master device 300 and the relevant network node 100 share a mobility management (MM) context and a security context relating to the master device 300.

During a registration, as currently described in 3GPP specifications, an MM context will be created in the respective MTC device and in the network node 100 for each MTC device. With regard to the embodiments of this invention, the most relevant components of the MM context are the temporary identity—e.g. packet temporary mobile subscriber identity (P-TMSI) for GPRS and 3G, globally unique temporary identity (GUTI) for LTE—and the registration area identity—e.g. routing area identity (RAI) for GPRS and 3G, tracking area identity (TAI) for LTE—assigned by the network node 100—e.g. SGSN for GPRS and 3G or MME for LTE. The temporary identity will be used by the group member 400 subsequently to identify itself when accessing the network directly, i.e. not via the master device 300. The registration area defines a set of cells within which an MTC device in idle mode can move without having to update the network about its current position. During the registration, if the used access technology is LTE, the MTC device and the network node 100 will also create a session management context including a context for a default bearer towards a packet data network.

In some embodiments of the invention, the master device 300 is interconnected with the group members 400 by a secure private network, e.g. using WLAN (wireless local area network) or Ethernet or Zigbee technology. This is possible in particular when all devices in a group are located in the same area. When the master device 300 sends a registration request (e.g. attach request) to the network, it indicates that it wants to perform a group registration. The indication may comprise a new parameter in the existing attach request message or a new group attach request message. Upon receipt of this registration request, the network initiates a group authentication.

In one possible embodiment (method 1), the group authentication is done as follows: The master 300 and the relevant network node 100 (SGSN/MME) take the session key established for the master 300 during authentication (e.g. GSM ciphering key (Kc), 3G ciphering key (CK) / 3G integrity key (IK), or EPS intermediate key (K_{ASME})) and derive further keys for the each group member 400 by applying a key derivation function to the master's 300 session key and data unique to the individual group members 400, e.g. an IMSI of a group member 400. Then the master 300 distributes the keys and key identifiers (Cipher Key Sequence Number (CKSN), Key Set Identifier (KSI), evolved packet system KSI (eKSI)) to each individual group member 400 via the secure private network. The key identifiers for the master's 300 and the group members' 400 session keys may be the same, or they may be individually assigned by the relevant network node 100. In the latter case, the message carrying the key identifiers may be enhanced so as to allow the sending of multiple key identifiers and the corresponding IMSIs. As for security reasons the IMSI of a group member 400 is preferably not sent via an unciphered signaling connection, and this message is only sent after ciphering has been activated for the signaling connection between the master device 300 and the network.

The group members 400 may have completely independent USIMs (universal subscriber identity modules), and they may be used any time for individual authentication procedures, but the keys established during group authentication are used in service requests if they want to save signaling. The keys established during group authentication are unrelated to any keys established by the group members' 400 USIMs.

The advantage this embodiment is reduction of signaling over the cellular air interface and reduction of load on the authentication centre (AuC) in the HSS 200.

In yet another possible embodiment (method 2), the group authentication is done as follows: The HSS/HLR 200, upon request for an authentication vector (AV) (set of parameters used for authentication and key agreement) for the master 300, also generates an AV for each group member 400, based on the group subscription data where all IMSIs in the group can be found, and sends all AVs to the SGSN/MME 100. As for security reasons the IMSI of a group member 400 is preferably not sent via an unciphered signaling connection, the message carrying the authentication challenge, e.g. random challenge (RAND) and/or authentication token (AUTN) parameters, and key identifiers together with the corresponding IMSIs for the group members 400 different from the master 300 should only be sent after ciphering has been activated for the signaling connection between master device 300 and network. Then the master 300 only distributes the authentication challenge RAND (AUTN) and key identifiers to the group members 400 via the secure private network. The group members 400 derive their session keys independently using their own USIMs.

The advantage of this embodiment is additional security as the master 300 does not know the session keys of the group members 400 anymore and reduction of signaling over the cellular air interface.

Once the group authentication has been completed successfully by the master device 300 and security (e.g. integrity protection and ciphering) has been activated for the signaling connection between the master device 300 and the network, the SGSN/MME 100 informs the HSS/HLR 200 about the attach request and retrieves subscriber data for the master 300 and the group members 400 from the HSS/HLR 200. As the subscriber data for all group members 400, including the master 300, can be assumed to be identical (apart from the

IMSI which is the permanent identity of an individual group member 400), the HSS/HLR 200 may transfer only one set of the subscriber data to the SGSN/MME 100. Additionally, the HSS/HLR 200 transfers a list of the IMSIs of all group members 400 to the network node 100. The list of IMSIs may be transferred either at this point within the procedure, possibly within the same message as the subscriber data, or it may be transferred already during the group authentication when the HSS/HLR 200 responds to the request for an authentication vector (AV) for the master 300.

The SGSN/MME 100 creates an individual MM context for each group member 400 using the subscriber data and the list of

IMSIs of the group members 400. This reduces the signaling load between SGSN/MME 100 and HSS/HLR 200 compared to the existing functionality where the subscriber data would be transferred for each group member 400 separately.

The network then indicates with one or several messages (e.g. attach accept messages) that it has accepted the group registration for the master device 300 and the group members 400. Additionally, the network provides the registration area (common for all group members 400) and one temporary identity for each group member 400 to the master device 300. If the used access technology is LTE, the network also provides session management information (e.g. session management context) necessary for creating a context for a default bearer towards a packet data network for each group member 400. When the network provides a temporary identity for a group member 400, it provides the master device 300 with an identifier, e.g. IMSI of the member device 400, which allows the master device 300 to forward the temporary identity to the correct group member 400.

The network also provides the master 300 with the authentication challenge RAND (AUTN) parameters (in case of method 2) and the key identifiers (in case method 2 or method 1 with individual key identifiers is used) for each group member 400 different from the master 300. This is preferably done only after activation of security, since for security reasons an IMSI of a group member 400 is preferably not sent via an unciphered signaling connection. Preferably IMSI, temporary identity, session management information, and RAND (AUTN) and key identifier, if any, are included within the same attach accept message to avoid that the network needs to provide the IMSI or another address identifier more than once.

The master device 300 distributes to the group members 400 via the secure private network:
temporary identities
registration area
key identifier (in case method 1 with individual key identifiers is used)
authentication challenge RAND (AUTN) parameter and key identifier (in case method 2 is used)
session management information, if the used access technology is LTE

Further, each group member 400 may confirm the receipt of this information to the master device 300 via the private network, and the master device 300 may forward the confirmations to the network. The forwarding of confirmations towards the network may be done in a single message (i.e. the master device 300 sends one message when it has received individual confirmations from all group members 400) or with several messages (i.e. the master device 300 sends one message for each individual confirmation from a group member 400 or it bundles several individual confirmations from group members 400 into one message).

The confirmations may enable the network to allocate resources (MM contexts, session management contexts) only for those group members 400 that were actually in communication with the master device 300 during the group registration.

When the group registration has been completed, each group member 400 may access the network individually and e.g. perform its own mobility management procedures. For example, if a group member 400 determines that it is not located within the registration area assigned during the group registration, it may initiate a routing area updating procedure (in GPRS and 3G) or a tracking area updating procedure (in LTE) to inform the network and get a new registration area assigned by the SGSN/MME 100.

In some further embodiments of the invention, no private network between the master device 300 and the member devices 400 is present. The group members 400 register individually as currently specified.

In one further embodiment (method 3), the HSS/HLR 200 receives a group register request relating to the master device 300 from SGSN/MME 100. HSS/HLR 200 generates an AV for each group member 400 and sends all AVs to the SGSN/MME 100. The group members 400 then register individually as currently specified. The advantage of this embodiment is that the number of messages between SGSN/MME 100 and HSS/HLR 200 is reduced. Furthermore, the registration/authentication of the master 300 may be done well ahead of the registration/authentication of the group members 400, and the latter procedure could then be performed fast as no AVs would have to be requested from the HSS/HLR 200.

In yet another further embodiment (method 4), the USIMs of all group members 400 may have the same long term key permanent key in 3G and EPS (K) or permanent key in GSM (Ki), but different IMSIs. The HSS 200 generates only one AV for the authentication of the master device 300. When the group members 400 access the network they are challenged by the SGSN/MME 100 so as to learn the challenge RAND (AUTN). Having the same cryptographic session keys as output of the USIMs for all members 400 of the group may create big security risks. Therefore, the key derivation is enhanced for all group members 400, including the master 300, so that somebody in control of a USIM cannot learn the session keys of the other group members 400.

The key derivation is performed as follows: In case of 3G or GSM, before the keys CK, IK in the case of 3G, or Kc in the case of GSM, are sent from the USIM to the ME they are hashed with data unique for the individual group member 400, e.g. with the IMSI, to provide CK′, IK′ or Kc′. On the network side, the HSS 200 or the SGSN performs the derivation of CK′, IK′ or Kc′ from CK, IK or Kc and IMSI.

In case of LTE, there are two alternatives.
a) K_{ASME} is computed in the HSS 200 as currently specified. K_{ASME} is computed in the same way in the USIM and not in the ME. Then K_{ASME} is hashed with the IMSI to derive K_{ASME}′. On the UE side, K_{ASME}′ is derived in the USIM. On the network side, K_{ASME}′ may be derived in the HSS 200 or in the MME.
b) K_{ASME} is derived in the HSS 200 from the hash of CK, IK and IMSI and sent to the MME. On the UE side, the hash of CK, IK and IMSI is computed in the USIM, but K_{ASME} may be computed in the ME. No K_{ASME}′ is needed.

According to one embodiment of the invention, the security information relating to group members 400 and the group master 300 may be stored in alternative ways in an authentication centre (AuC). According to a first alternative, there are no separate entries for the group members 400 in the AuC, only one entry for the master 300. In this alternative, the group members 400 are completely dependent on the master 300, and if the master has deregistered they cannot access the network any more. According to a second alternative, there are separate entries for the group members 400 in the AuC, all with the same long term key K/Ki. Then each group member 400 may perform individual authentication procedures with the network.

In yet another embodiment, the group members 400 have two USIMs each on their UICC (universal integrated circuit card). One USIM acts according to the first alternative, i.e. it has no counterpart in the AuC and is used only in group-related procedures. With the other USIM, the group member 400 acts like a standardized 3GPP rel-8 UE, i.e. the other USIM has a counterpart in the AuC and is unrelated to the group. Using this second USIM the group member 400 is able to act independently of the group if needed.

1. A method comprising:
receiving a group registration request from a master device;
sending a request relating to said master device to a subscriber database; and
receiving subscriber specific information relating to at least one member device from said subscriber database;
wherein said at least one member device is controlled by said master device and said subscriber specific information relating to said at least one member device is associated with said master device in said subscriber database.

2. The method according to claim 1, further comprising deriving a mobility management context for said at least one member device based on said received subscriber specific information relating to said at least one member device.

3. The method according to claim 1, further comprising receiving at least one security parameter from said subscriber database.

4. The method according to claim 3, wherein said at least one received security parameter relates to said master device and the method further comprises deriving security keys for said at least one member device based on said at least one security parameter relating to said master device and said subscriber specific information related to said at least one member device.

5. The method according to claim 1, further comprising sending at least one security parameter to said master device or to said at least one member device, wherein said at least one security parameter is sent together with said at least one subscriber specific information relating to said at least one member device.

6. The method according to claim 1, wherein said at least one member device is a member of a machine type communications device group and said master device is configured to control said at least one member device of said machine type communications device group.

7. The method according to claim 1, wherein said subscriber specific information relating to said at least one member device comprises international mobile subscriber identity or a parameter associated with international mobile subscriber identity.

8. A network node comprising:
a first input configured to receive a group registration request from a master device;
an output configured to send a request relating to said master device to a subscriber database; and
a second input configured to receive subscriber specific information relating to at least one member device from said subscriber database;
wherein said at least one member device is controlled by said master device and said subscriber specific information relating to said at least one member device is associated with said master device in said subscriber database.

9. The network node according to claim 8, further comprising a processor configured to derive at least one of a mobility management context and a security context for said at least one member device based on said received subscriber specific information relating to said at least one member device.

10. The network node according to claim 8, wherein said second input is further configured to receive at least one security parameter from said subscriber database.

11. The network node according to claim 10, wherein said at least one received security parameter relates to said master device and said processor is further configured to derive security keys for said at least one member device based on said at least one security parameter relating to said master device and said subscriber specific information related to said at least one member device.

12. The network node according to claim 8, wherein said output is further configured to send at least one security parameter to said master device or to said at least one member device, wherein said at least one security parameter is sent together with said at least one subscriber specific information relating to said at least one member device.

13. The network node according to claim 8, wherein said at least one member device is a member of a machine type communications device group and said master device is configured to control said at least one member device of said machine type communications device group.

14. The network node according claim 8, wherein said subscriber specific information relating to said at least one member device comprises international mobile subscriber identity or a parameter associated with international mobile subscriber identity.

15. A subscriber database comprising:
a memory configured to store subscriber specific information relating to a master device and subscriber specific information relating to at least one member device;
a input configured to receive a request relating to said master device from a network node; and
a output configured to send subscriber specific information relating to at least one member device to said network node;
wherein said at least one member device is controlled by said master device and said subscriber specific information relating to said at least one member device is associated with said master device in said memory.

16. The subscriber database according to claim 15, wherein said output is further configured to send at least one security parameter to said network node.

17. The subscriber database according to claim 16, wherein said at least one security parameter comprises an authentication parameter, a security key or a key identifier.

18. The subscriber database according to claim 15, wherein said at least one member device is a member of a machine type communications device group and said master device is configured to control said at least one member device of said machine type communications device group.

19. The subscriber database according to claim 15, wherein said subscriber specific information relating to said at least one member device comprises international mobile subscriber identity or a parameter associated with international mobile subscriber identity.

20. A mobile device comprising:
a output configured to send a group registration request to a network node;
a input configured to receive subscriber specific information relating to at least one member device from said network node;
wherein said at least one member device is controlled by said mobile device and said subscriber specific information relating to said at least one member device is associated with said mobile device in said subscriber database.

21. The mobile device according to claim 20, wherein said input is further configured to receive at least one of said temporary mobile subscriber identity, said tracking area identifier, said location area identifier and said routing area identifier from said network node.

22. The mobile device according to claim 20, wherein said input is further configured to receive at least one security parameter from said network node.

23. The mobile device according to claim 20, wherein said output is further configured to send at least one of a temporary identity, a registration area, an authentication parameter, a security key, a key identifier and a session context to said at least one member device.

24. The mobile device according to claim 20, wherein said at least one member device is a member of a machine type communications device group and said mobile device is a master device configured to control said at least one member device of said machine type communications device group.

25. The mobile device according to claim 20, wherein said subscriber specific information relating to said at least one member device comprises international mobile subscriber identity or a parameter associated with international mobile subscriber identity.

26. A system, comprising:
a network node comprising a first input configured to receive a group registration request from a master device;
an output configured to send a request relating to said master device to a subscriber database; and
a second input configured to receive subscriber specific information relating to at least one member device from said subscriber database;
wherein said at least one member device is controlled by said master device and said subscriber specific information relating to said at least one member device is associated with said master device in said subscriber database; and
the subscriber database according to claim 15.

27. A computer program product comprising code means configured to perform all the steps of claim 1 when the program is run on a processor.
